(19) United States
(12) Patent Application Publication
(10) Pub. No.: US 2008/0297479 A1
(43) Pub. Date: Dec. 4, 2008

(54) Industrial portable data processing device with a keyboard set replaceable

(75) Inventor: Tseng-Sung Yeh, Taipei (TW)

Correspondence Address: BIRCH STEWART KOLASCH & BIRCH, PO BOX 747, FALLS CHURCH, VA, 22040-0747, US

(73) Assignee: SHIN CHUAN COMPUTER CO. LTD.

(21) Appl. No.: 11/806,630

(22) Filed: Jun. 1, 2007

(51) Int. Cl. G06F 3/02

(52) U.S. Cl. 345/169

(57) ABSTRACT

An industrial portable data processing device with a replaceable keyboard set comprises a device body, a short/long keyboard set, a keyboard extension part and a scanning part. A display is provided on the device body, under which the long or short keyboard set may be assembled following a user's request (s). However, before the long keyboard set is assembled, the keyboard extension part must be wedged into the tail of device body and the scanning part is combined into the bottom of the device body; thereby the device with the replaceable keyboard set being formed. This invention makes the user choose a long/short keyboard set depending on his or her request(s), being provided with an effect of two applications in a machine to avoid the necessity of having many devices working at the same time or serving for backup due to the differences of conventional operating environments, functions, and habits.

### FIELD OF THE INVENTION

This invention relates to an industrial portable data processing device with a replaceable keyboard set, particularly to a Portable Data Terminal (PDT) or a Personal Digital Assistant (PDA), which may provide with a long or short keyboard set upon a user's request.

### BACKGROUND OF THE INVENTION

In accordance with different functions, conventional industrial PDA devices may be briefly divided into two models: long and short keyboard sets. A user chooses one of the above-mentioned PDA models depending on his or her request(s). Thus, for the convenience of operation, it is no wonder that the user meanwhile has the PDA devices with the long and short keyboard sets. However, for the user, the cost of purchase or maintenance of two PDA devices is too high, thereby the user being not capable of carrying the burden.

Thus, it can be seen that the conventional PDA device nonetheless has many defects, so it is not a good design and must be urgently improved.

In consideration of the various defects derived from the conventional PDA device, this inventor further improved it and finally successfully developed the industrial portable data processing device with a replaceable keyboard set, after having made extraordinarily painstaking efforts to study the frame diligently with a quiet mind for many years.

Consequently, because of the above-described technical defects, the applicant keeps on carving unflaggingly through wholehearted experience and research to develop the present invention, which can effectively improve the defects described above.

### SUMMARY OF THE INVENTION

It is an objective of this invention to mainly provide the industrial portable data processing device with the replaceable keyboard set. With such a structure design, a user may choose a long or short keyboard set according to his or her request(s), and the portable data processing device may further be assembled with a long or short keyboard set.

It is an another objective of this invention to provide the industrial portable data processing device with the replaceable keyboard set, being provided with an effect of two applications in a machine to avoid the necessity of having many devices working at the same time or serving for backup due to the differences of conventional operating environments, functions, and habits. It is a further objective of this invention to provide the industrial portable data processing device with the replaceable keyboard set, being featured with easy assembly and replacement, easy operation, wide range of application, high security, high cost efficiency, and long service life.

The industrial portable data processing device with the replaceable keyboard set according to this invention is made up with a device body, a short keyboard set, a long keyboard set, a keyboard extension part, and a scanning part. A display is provided on the device body, under which the long or short keyboard set may be assembled depending on the user's request(s). However, before the long keyboard set is assembled, the keyboard extension part must be wedged into the tail of device body. Finally the scanning part is combined into the bottom of the device body, thereby industrial portable data processing device with the replaceable keyboard set being formed.

### BRIEF DESCRIPTION OF THE DRAWINGS

FIG. 1 is an exploded view of an industrial portable data processing device with a long keyboard set according to this invention;

FIG. 2 is a 3D view of an industrial portable data processing device with a long keyboard set;

FIG. 3 is an exploded view of an industrial portable data processing device with a short keyboard set; and

FIG. 4 is a 3D view of an industrial portable data processing device with a short keyboard set.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

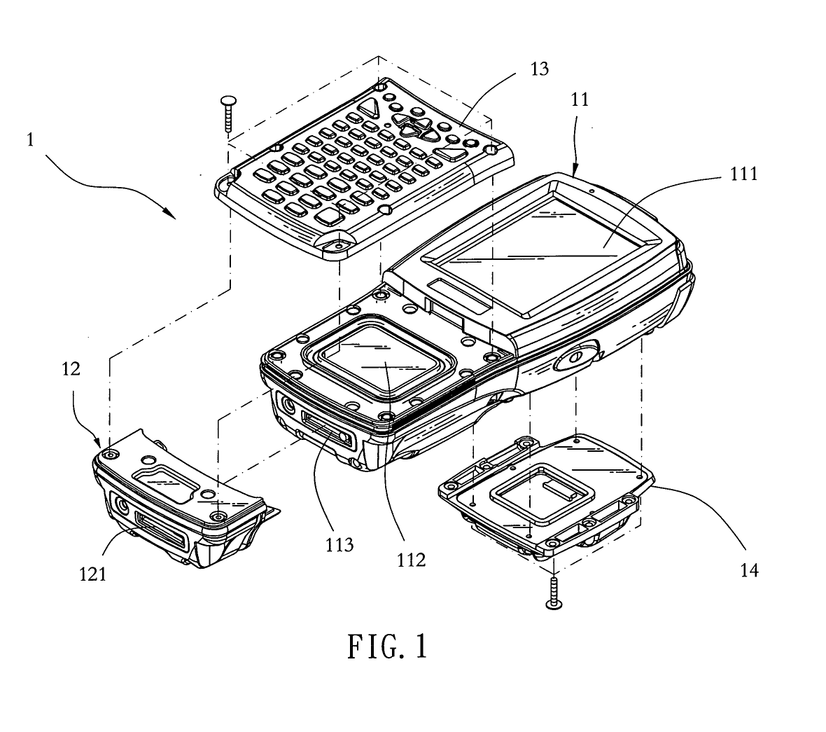

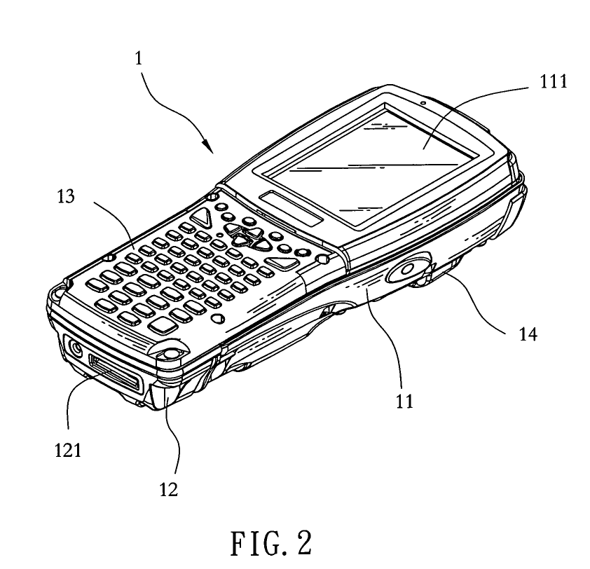

FIGS. 1 and 2 are exploded and 3D views of an industrial portable data processing device with a long replaceable keyboard set according to this invention, respectively. In the figures, the industrial portable data processing device 1 with the long keyboard set according to this invention comprises:

a device body 11, in which a display 111 is provided on the device body 11, a link portion 112 is provided under the display 111, a keyboard extension part 12 may be connected to the tail of device body 11, next a long keyboard set 13 may be combined onto the top of device body 11, and a scanning part 14 may be combined onto the bottom of device body 11;

a keyboard extension part 12 that may be wedged into a connector 113 at the tail of device body 11, in which a connector 121 is likewise provided at the tail of keyboard extension part 12;

a long keyboard set 13, after the keyboard extension part 12 is connected to the device body 11, may be combined onto the link portion 112 formed with the device body 11 and the keyboard extension part 12; and

a scanning part 14 that may be installed to the bottom of device body 11.

After the above-mentioned members are assembled, the industrial portable data processing device 1 with the replaceable keyboard set may be formed.

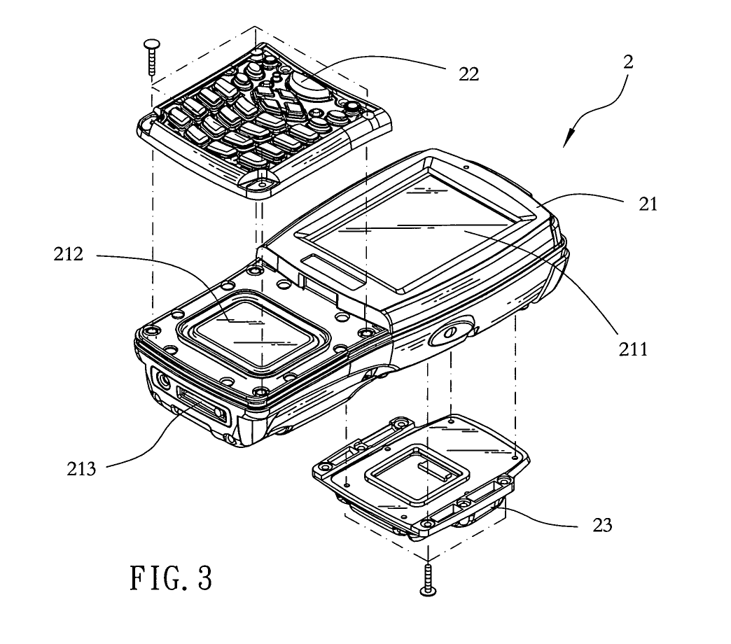

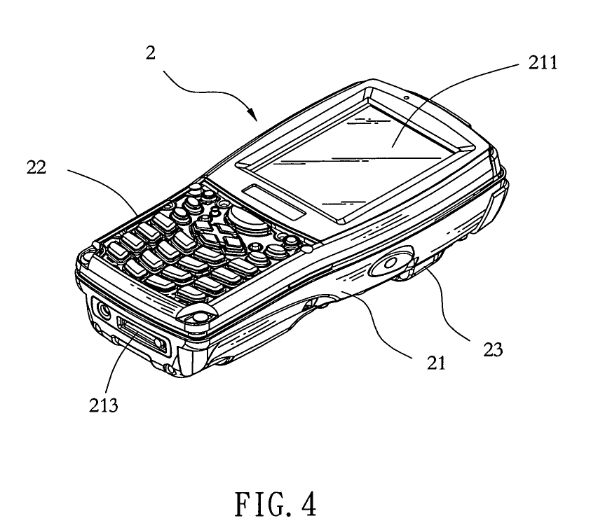

FIGS. 3 and 4 are exploded and 3D views of the industrial portable data processing device with a short keyboard set according to this invention, respectively. In the figures, the industrial portable data processing device 2 with the short keyboard set according to this invention comprises:

a device body 21, in which a display 211 is provided on the device body 21, a connector 213 is provided at the tail of device body 21, a link portion 212 is provided under the display 211, a short keyboard set 22 is combined onto the top of the link portion 212, and a scanning part 23 may be linked to the bottom of device body 21;

a short keyboard set 22 that may be connected to the top of link portion 212 of the device body 21; and

a scanning part 23 that may be connected to the bottom of the device body 21.

After the above-mentioned members are assembled, the industrial portable data processing device 2 with the replaceable keyboard set may be formed.

What is mentioned above is the description of embodiment of this invention that may be implemented. However, in the description mentioned above, only the preferred embodiments according to this invention are provided without limit to this invention and the characteristics of this invention; all those skilled in the art without exception should include the equivalent changes and modifications as falling within the true scope and spirit of the present invention.

To sum up, from the disclosed art, this invention may provide a design widely different from the conventional design, which increases the entire use value, and further this invention is indeed unprecedented and has not been published and not similar to any other product in the market, so it completely meets the requirements of application for the patent. We earnestly request that this application be examined in detail and approved as soon as possible for protection of the inventor's rights and interests. Please feel free to contact us if you, the examiner, have any questions at the time of examination.

What is claimed is:

1. An industrial portable data processing device with a replaceable keyboard set, comprising a device body, a short keyboard set, a long keyboard set, a keyboard extension part, and a scanning part; in which a display is provided on the device body, and a link portion is provided under the display and may be optionally combined with the long or short keyboard set for use, however, in which before the long keyboard set is assembled for use, the keyboard extension part must be wedged into the tail of device body, and finally the scanning part is combined onto the bottom of device body, thereby industrial portable data processing device with the replaceable keyboard set being formed.

2. The industrial portable data processing device with the replaceable keyboard set according to claim 1, wherein the industrial portable data processing device with the long replaceable keyboard set comprises:
a device body, in which a display is provided on the device body, a link portion is provided under the display, a keyboard extension part may be connected to the tail of device body, next a long keyboard set may be combined onto the top of device body, and a scanning part may be combined onto the bottom of device body;
a keyboard extension part that may be wedged into a connector at the tail of device body, in which a connector is likewise provided at the tail of keyboard extension part;
a long keyboard set, in which after the keyboard extension part is connected to the device body, the long keyboard set may be combined onto the link portion formed with the device body and the keyboard extension part; and
a scanning part that may be connected to the bottom of device body;
After the above-mentioned members are assembled, the industrial portable data processing device with the replaceable keyboard set being formed.

3. The industrial portable data processing device with the keyboard set replaceable according to claim 1, wherein the industrial portable data processing device with the short replaceable keyboard set comprises:
a device body, in which a display is provided on the device body, a connector is provided at the tail of device body, a link portion is provided under the display, a short keyboard set is combined onto the top of the link portion, and a scanning part may be linked to the bottom of device body;
a short keyboard set that may be connected to the top of link portion of the device body; and
a scanning part that may be connected to the bottom of device body;
After the above-mentioned members are assembled, the industrial portable data processing device with the replaceable keyboard set being formed.

4. The industrial portable data processing device with the replaceable keyboard set according to claim 1, wherein the industrial portable data processing device with the short replaceable keyboard set may be a Personal Digital Assistant (PDA).

5. The industrial portable data processing device with the replaceable keyboard set according to claim 1, wherein the industrial portable data processing device with the short replaceable keyboard set may be a Portable Data Terminal (PDT).
